(19) United States
(12) Patent Application Publication
(10) Pub. No.: US 2026/0361816 A1
(43) Pub. Date: Nov. 12, 2026

(54) CONTEXT-SPECIFIC AUTOMATIC ADJUSTMENT OF SIDETONE

(71) Applicant: Avaya Management L.P., Morristown, NJ (US)

(72) Inventor: Paul Roller Michaelis, Louisville, CO (US)

(21) Appl. No.: 19/203,125

(22) Filed: May 8, 2025

(51) Int. Cl. H04M 1/58; G10L 25/78; H04M 9/08

(52) U.S. Cl. CPC H04M 1/585; G10L 25/78; H04M 9/08

(57) ABSTRACT

Telecommunication endpoints include “sidetone” mechanisms that transmit captured sound from the user's microphone to the user's handset or headset. Systems and methods herein provide variable sidetone. When a user is determined to be speaking, the amplitude of the sidetone is adjusted to be similar to what the user would perceive if the covered ear was not covered, thereby allowing users to adjust how loudly they are speaking. When the user of the endpoint is not speaking, the sidetone is muted or attenuated, thereby ensuring that noise at the user's location will not interfere with the user's ability to hear the far-end party.

### FIELD OF THE DISCLOSURE

The invention relates generally to systems and methods for telephony endpoints and particularly to context-specific automatic adjustment of sidetone amplitude of a telephony endpoint.

### BACKGROUND

People who are using a telephone handset in a noisy environment, who are having a hard time hearing the far-end party, can often be observed using the free hand to cover the opposite ear. This doesn't work nearly as well as covering the handset's microphone. The problem is sidetone.

In telecommunication endpoints, in which the user has a handset or headset, “sidetone” refers to the intentional electronic transmission of the user's voice to the user's ear while the user is speaking. This allows users to hear their own voice at the same level they would hear it with an uncovered ear, thereby giving them acoustic feedback about how loudly they are speaking. The so-called cellphone shout, in which users speak much too loudly, is often because the sidetone amplitude of their phone is too low.

In noisy environments, a sidetone level that is optimized for allowing the user to hear his own voice at an appropriate level also tends to transmit the background noise to the user's ear while the user is trying to hear the far-end party. The net effect is an intelligibility-harming reduction in the signal-to-noise ratio of the received speech, as measured at the user's ear.

Prior art methods for reducing the transmission of ambient noise to the user's ear include highly directional microphones that are less sensitive to off-axis sounds and expander circuits that automatically attenuate the signal from the microphone even further when the input level drops below a pre-specified threshold. Both of these approaches have drawbacks. A disadvantage of directional microphones is that they filter-out the voice of the user if not positioned directly in front of the user's mouth. A disadvantage of expander circuits is their tendency to engage and disengage the attenuator inappropriately.

Telecommunication endpoints that allow users to adjust the sidetone level are known. (See, for example, “What Is Sidetone and How Can It Help You?” by JPL Telecom, available at “www. jpltele.com/news/what-is-sidetone-and-how-can-it-help-you/,” which is incorporated herein by reference.) Support for manual control of sidetone level is not a satisfactory solution. Reasons include: (1) the sidetone level that's appropriate when the user is speaking is unlikely to be appropriate when the user is in a noisy environment and struggling to hear the far-end party, (2) background noise levels can change mid-call, especially when mobile endpoints are being used, and (3) users cannot be relied upon to make the appropriate adjustments. (For example, users who are trying to hear the far-end party might respond to increased noise in the local environment by increasing the receive amplitude rather than by decreasing the sidetone level.)

### SUMMARY

The prior art does not take into account that, in noisy environments, the optimal sidetone level when the user is speaking and the optimal sidetone level when the user is listening are likely to be different.

These and other needs are addressed by the various embodiments and configurations of the present invention. The present invention can provide a number of advantages depending on the particular configuration. These and other advantages will be apparent from the disclosure of the invention(s) contained herein.

When a user is speaking, embodiments herein adjust the sidetone so that, in the covered ear(s), the user hears their own voice at the same level he would hear it in an uncovered ear. When the user is in a noisy environment and not speaking, the proposed solution adjusts the sidetone to provide a signal-to-noise ratio for received speech equal to or better than the level required for good intelligibility.

In one embodiment, the user's telecommunication endpoint would continuously determine whether the audio received from the user's microphone is the user's voice. If the audio is the user's voice, the user's endpoint would adjust the sidetone amplitude to a level approximating how the user's voice would sound to the user if the covered ear were not covered.

In another embodiment, if the audio received from the user's microphone is not the user's voice, the user's telecommunication endpoint would continuously: (1) measure the amplitude of the noise received from the user's microphone, (2) measure the amplitude of the audio signal received from the far-end endpoint, such as the amplitude of the far-end user's voice, (3) determine the signal-to-noise ratio of the audio being transmitted to the user's ear, and (4) adjust the sidetone amplitude to achieve a signal-to-noise ratio equal to or better than the level required for the received speech to be fully intelligible.

The difference in amplitude between the loud components of human speech, such as vowels and voiced plosives, and the soft components, such as unvoiced fricatives, can be over 35 dB. In order to take this variability into account, and not be fooled by noise at the far-end location, in one embodiment the peak amplitude of the received speech is used when computing the signal-to-noise ratio. When measured in this manner, a signal-to-noise ratio of 50 dB will often be sufficient for good intelligibility.

In another embodiment, adjustments or modifications to other embodiments are provided which may be based on the user's endpoint's audio output mechanism. For example, the device may respond to sound differently for a standard single-ear telephone handset versus a two-ear headset that has an excellent acoustic seal, or earbuds that have a poor acoustic seal.

In addition to automatic adjustment of sidetone level, in another embodiment, automatic adjustment of the receive and transmit amplitudes are provided. For example, if an acceptable signal-to-noise ratio is not achievable by adjusting the sidetone level—perhaps because the unmodified signal being received from the far end is too low—adjustments to the receive amplitude are provided.

In some aspects, the techniques described herein rate to a device for communicating via a network with a far-end device, comprising: a microphone; a first audio output transducer; and a processor; and wherein the processor determines whether sound received by the microphone comprises speech from a user of the device versus sound absent speech from the user; and wherein the processor, upon determining the sound comprises speech from the user of the device, automatically enables a sidetone, providing the sound to the first audio output transducer; and wherein the processor, upon determining the sound is absent speech from the user, automatically attenuates the sidetone.

In some aspects, the techniques described herein relate to a device wherein a binaural set of audio output transducers that comprise the first audio output transducer and a second audio output transducer.

In some aspects, the techniques described herein relate to a device wherein the processor attenuates the sidetone comprising muting the sidetone.

In some aspects, the techniques described herein relate to a device wherein the processor attenuates the sidetone comprising, attenuating at least one sidetone frequency associated with signals from the microphone comprising at least one of environmental sound or sound other than speech from the user.

In some aspects, the techniques described herein relate to a device wherein the processor determining that speech from a user utilizing the far-end device is present and, in response, automatically attenuating the sidetone.

In some aspects, the techniques described herein relate to a method wherein the sound received by the microphone is provided, via the network, as electrical signals to the far-end device.

In some aspects, the techniques described herein relate to a device wherein the first audio output transducer generates sound in response to receiving electrical signals, via the network, from the far-end device.

In some aspects, the techniques described herein relate to a device wherein the device comprises a headset.

In some aspects, the techniques described herein relate to a device wherein the device comprises a telephone.

In some aspects, the techniques described herein relate to a device wherein the volume of the sidetone is selected in accordance with a determined volume of the user as feedback to an unobstructed ear of the user.

In some aspects, the techniques described herein relate to a method, comprising: receiving an electrical signal from a microphone of a device in response to sound; analyzing the electrical signal to determine whether the sound received by the microphone comprises speech from a user; upon determining the sound comprises speech from the user of the device, automatically enabling a sidetone, providing the sound to a first audio output transducer of the device; and upon determining the sound is absent speech from the user, automatically attenuating the sidetone.

In some aspects, the techniques described herein relate to a method further comprising a binaural set of audio output transducers that comprise the first audio output transducer and a second audio output transducer.

In some aspects, the techniques described herein relate to a method wherein attenuating the sidetone comprises muting the sidetone.

In some aspects, the techniques described herein relate to a method wherein attenuating the sidetone comprises attenuating at least one sidetone frequency associated with signals from the microphone comprising at least one of environmental sound or sound other than speech from the user.

In some aspects, the techniques described herein relate to a method further comprising determining that speech received, via a network, from a far-end device is present and, in response, automatically attenuating the sidetone.

In some aspects, the techniques described herein relate to a method wherein the sound received by the microphone is provided, via a network, as electrical signals to a far-end device.

In some aspects, the techniques described herein relate to a method wherein the first audio output transducer generates sound in response to receiving electrical signals, via a network, from a far-end device.

In some aspects, the techniques described herein relate to a method further comprising: determining volume of speech of the user as it would be observed by an unobstructed ear of the user; and setting the sidetone in accordance with the determined volume of speech of the user.

In some aspects, the techniques described herein relate to a computer-readable medium coupled to a processor, the computer-readable medium comprising one or more computer readable instructions, the processor executing the one of more computer readable instructions to: receive an electrical signal from a microphone of a device in response to sound; analyze the electrical signal to determine whether the sound received by the microphone comprises speech from a user; upon determining the sound comprises speech from the user of the device, automatically enabling a sidetone providing the sound to a first audio output transducer of the device; and upon determining the sound is absent speech from the user, automatically attenuating the sidetone.

In some aspects, the techniques described herein relate to a computer-readable medium wherein automatically attenuating the sidetone comprises attenuating at least one sidetone frequency associated with signals from the microphone comprising at least one of environmental sound or sound other than speech from the user.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts acoustic waveforms over time in accordance with at least some embodiments of the present disclosure;

FIG. 3 depicts a process in accordance with embodiments of the present disclosure; and

FIG. 4 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

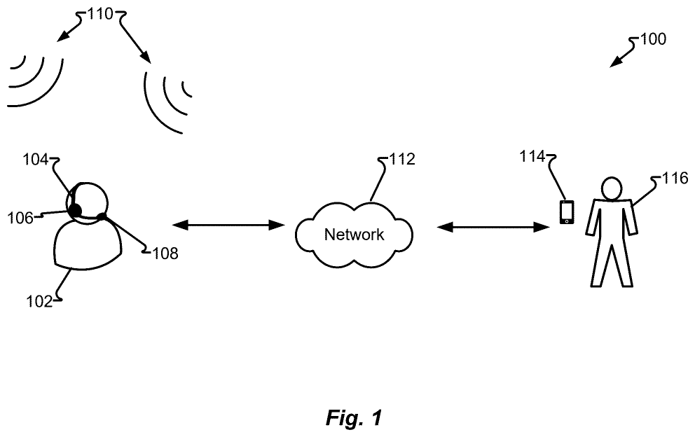

FIG. 1 depicts communication system 100 in accordance with at least some embodiments of the present disclosure. Communication system 100 omits many well-known features of telecommunication systems, whether analog, digital, or a combination thereof, for the sake of clarity and avoiding unnecessarily complicating the figure and description.

In one embodiment, user 102 is speaking with far-end user 116 via network 112. Network 112 may be digital (e.g., packetized) and/or analog and be or comprise plain old telephone system (POTS), internet, private network (e.g., intranet, private branch exchange (PBX)), cellular, satellite, intercom, etc., or combinations thereof. Far-end user 116 may be in a noisy environment and environmental sound 110 may be significantly loud as to cause user 102, specifically, and/or users within the same environment, to have difficulty hearing sufficiently clear sound from audio output transducer 106 of headset 104, which may be utilized to convey speech from user 116 via far-end device 114. It should be appreciated that headset 104 is one embodiment comprising microphone 108. In other embodiments, headset 104 may be a monoaural or binaural headset or an audio output transducer of a device (e.g., a telephone handset, speakerphone, cellular phone, walkie-talkie, earbuds, etc.)

In another embodiment, microphone 108 converts sound energy into electrical signals for delivery to far-end device 114 of far-end user 116. Headset 104 (or another device associated with headset 104, such as a computer's sound processor used to process audio to/from headset 104) comprises a processor to selectively provide audio output transducer 106 with a portion of the sound captured by microphone 108 (i.e., sidetone).

In one embodiment, when microphone 108 is determined to capture sound comprising speech from user 102, sidetone is enabled, thereby providing speech from user 102 into audio output transducer 106. The processor determines a volume of sound to be provided by audio output transducer 106, which is equivalent to what the user 102 would observe for their own speech with an unaided and unobscured ear. When the sound captured by microphone 108 does not include speech from user 102, sidetone is attenuated at least partially and optionally completely. As a benefit, user 102 hears the sound of their own speech at a normal level, which is also conveyed to far-end device 114.

Attenuating the sidetone may be across all audio frequencies or select frequencies, such as those associated with environmental sound 110. The processor utilized by headset 104 may learn frequencies associated with speech from user 102, such as by determining the frequencies of environmental sound 110 while speech is originating from far-end user 116, frequencies of the dominate sound (i.e., speech from user 102) and/or recognizable speech, the frequencies of environmental sound 110, etc.

The degree of attenuation provided by the processor may be further determined by the particular form factor of headset 104. For example, when headset 104 is embodied as earbuds (or another device with relatively poor acoustic seal), the amount of sidetone provided by audio output transducer 106 may be more limited as more of the speech from user 102 will be heard by their own ears. In contrast, audio output transducer(s) from a binaural headset with a good acoustic seal will provide a louder sidetone as less of the speech from user 102 will be heard through the ear cups of headset 104.

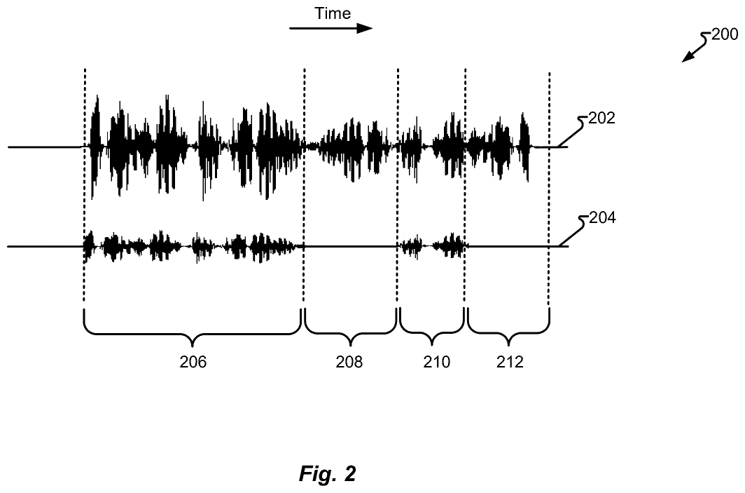

FIG. 2 depicts acoustic waveforms 200 over time in accordance with at least some embodiments of the present disclosure. In one embodiment, waveform 202 illustrates sound (and the sound's relative amplitude) as observed, such as by microphone 108 or a processor processing electrical signals from microphone 108. Waveform 204 illustrates a sidetone presented by an audio output transducer, such as audio output transducer 106 providing sound back to a user, such as user 102, providing the speech.

At time 206, user 102 is speaking and an attenuated portion of waveform 202 is provided as waveform 204. At time 208, speech from user 102 is absent and/or sound observed is determined to originate solely from environmental sound 110. Optionally, during time 208, a far-end device, such as far-end device 114, is provided with the same or equivalent audio signal. During time 208, waveform 202 is receiving sound, such as environmental sound 110, and, as a result, waveform 204 during time 208 provides no sidetone. Once the microphone again detects speech, such as during time 210, sidetone is again provided (at the same or attenuated volume) during time 210. When speech stops during time 212, sound detected during time 212 is omitted from waveform 204 and not presented as sidetone or, if presented, attenuated.

In another embodiment, spectrographic analyses of waveform 202 allows for additional or alternative attenuation techniques to be performed. For example, if the analyses determine that the background noise is concentrated at specific acoustic frequencies, the attenuation mechanism could selectively remove from the sidetone sounds at those frequencies. Similarly, spectrographic analyses of user 102's speech (e.g., determination of the formant structures that correspond to user 102's vocal tract resonances) would allow the system to distinguish between user 102's speech and background voices.

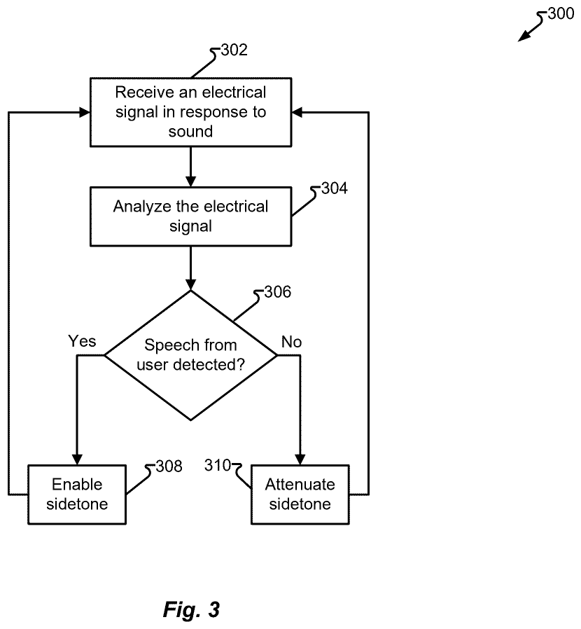

FIG. 3 depicts process 300 in accordance with embodiments of the present disclosure. In one embodiment, process 300 is embodied as machine-readable instructions maintained in a non-transitory memory that when read by a machine, such as processors of a device, causes the machine to execute the instructions and thereby execute process 300. The processor of the device may include, but is not limited to, at least one processor of headset 104 or an audio processing component (e.g., a sound processor of a computer, audio components of a cellular telephone, etc.).

In one embodiment, process 300 begins and, in step 302 an electrical signal is received in response to sound, such as sound captured and converted to electrical (analog or digital) signals by microphone 108. Step 304 analyzes the electrical signal and test 306 determines whether or not speech from the user, such as user 102, is detected. If test 306 determines speech from the user is detected, processing continues to step 308, wherein the sidetone is enabled (or de-attenuated). If test 306 determines speech from the user is not detected, processing continues to step 310 and the sidetone is disabled (or attenuated). Processing then loops back to step 302 and continues indefinitely or until interrupted.

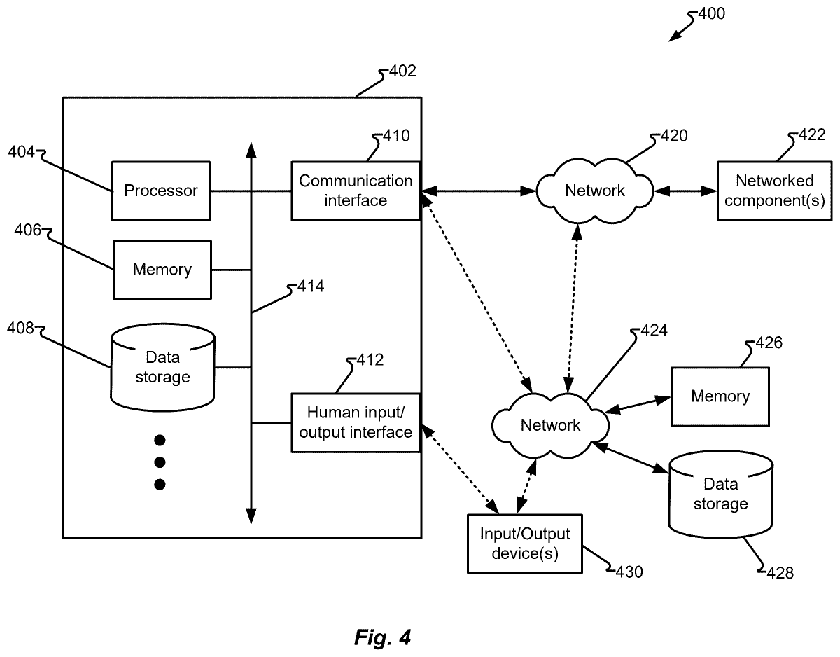

FIG. 4 depicts device 402 in system 400 in accordance with embodiments of the present disclosure. In one embodiment, headset 104 and/or an audio processing component associated with headset 104 (e.g., audio processing component(s) of a cellular telephone, computer, handset, etc.) may be embodied, in whole or in part, as device 402 comprising various components and connections to other components and/or systems. The components are variously embodied and may comprise processor 404. The term “processor,” as used herein, refers exclusively to electronic hardware components comprising electrical circuitry with connections (e.g., pin-outs) to convey encoded electrical signals to and from the electrical circuitry. Processor 404 may comprise programmable logic functionality, such as determined, at least in part, from accessing machine-readable instructions maintained in a non-transitory data storage, which may be embodied as circuitry, on-chip read-only memory, computer memory 406, data storage 408, etc., that cause the processor 404 to perform the steps of the instructions. Processor 404 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 414, executes instructions, and outputs data, again such as via bus 414. In other embodiments, processor 404 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 404 is a non-transitory computing device (e.g., electronic machine comprising circuitry and connections to communicate with other components and devices). Processor 404 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 404). Processor 404 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 404, device 402 may utilize computer memory 406 and/or data storage 408 for the storage of accessible data, such as instructions, values, etc. Communication interface 410 facilitates communication with components, such as processor 404 via bus 414 with components not accessible via bus 414 and may be embodied as a network interface (e.g., ethernet card, wireless networking components, USB port, etc.). Communication interface 410 may be embodied as a network port, card, cable, or other configured hardware device. Additionally or alternatively, human input/output interface 412 connects to one or more interface components to receive and/or present information (e.g., instructions, data, values, etc.) to and/or from a human and/or electronic device. Examples of input/output devices 430 that may be connected to input/output interface include, but are not limited to, keyboard, mouse, trackball, printers, displays, sensor, switch, relay, audio output transducer, microphone, still and/or video camera, etc. In another embodiment, communication interface 410 may comprise, or be comprised by, human input/output interface 412. Communication interface 410 may be configured to communicate directly with a networked component or configured to utilize one or more networks, such as network 420 and/or network 424.

Network 112 may be embodied, in whole or in part, as network 420. Network 420 may be a wired network (e.g., Ethernet), wireless (e.g., WiFi, Bluetooth, cellular, etc.) network, or combination thereof and enable device 402 to communicate with networked component(s) 422. In other embodiments, network 420 may be embodied, in whole or in part, as a telephony network (e.g., public switched telephone network (PSTN), private branch exchange (PBX), cellular telephony network, etc.).

Additionally or alternatively, one or more other networks may be utilized. For example, network 424 may represent a second network, which may facilitate communication with components utilized by device 402. For example, network 424 may be an internal network to a business entity or other organization, whereby components are trusted (or at least more so) than networked components 422, which may be connected to network 420 comprising a public network (e.g., Internet) that may not be as trusted.

Components attached to network 424 may include computer memory 426, data storage 428, input/output device(s) 430, and/or other components that may be accessible to processor 404. For example, computer memory 426 and/or data storage 428 may supplement or supplant computer memory 406 and/or data storage 408 entirely or for a particular task or purpose. As another example, computer memory 426 and/or data storage 428 may be an external data repository (e.g., server farm, array, “cloud,” etc.) and enable device 402, and/or other devices, to access data thereon. Similarly, input/output device(s) 430 may be accessed by processor 404 via human input/output interface 412 and/or via communication interface 410 either directly, via network 424, via network 420 alone (not shown), or via networks 424 and 420. Each of computer memory 406, data storage 408, computer memory 426, data storage 428 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 430 may be a router, a switch, a port, or other communication component such that a particular output of processor 404 enables (or disables) input/output device 430, which may be associated with network 420 and/or network 424, to allow (or disallow) communications between two or more nodes on network 420 and/or network 424. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A 7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A device for communicating via a network with a far-end device, comprising:
a microphone;
a first audio output transducer; and
a processor; and
wherein the processor determines whether sound received by the microphone comprises speech from a user of the device versus sound absent speech from the user; and
wherein the processor, upon determining the sound comprises speech from the user of the device, automatically enables a sidetone, providing the sound to the first audio output transducer; and
wherein the processor, upon determining the sound is absent speech from the user, automatically attenuates the sidetone.

2. The device of claim 1, further comprising a binaural set of audio output transducers that comprise the first audio output transducer and a second audio output transducer.

3. The device of claim 1, wherein the processor attenuates the sidetone comprising muting the sidetone.

4. The device of claim 1, wherein the processor attenuates the sidetone comprising attenuating at least one sidetone frequency associated with signals from the microphone comprising at least one of environmental sound or sound other than speech from the user.

5. The device of claim 1, further comprising the processor determining that speech from a user utilizing the far-end device is present and, in response, automatically attenuating the sidetone.

6. The device of claim 1, wherein the sound received by the microphone is provided, via the network, as electrical signals to the far-end device.

7. The device of claim 1, wherein the first audio output transducer generates sound in response to receiving electrical signals, via the network, from the far-end device.

8. The device of claim 1, wherein the device comprises a headset.

9. The device of claim 1, wherein the device comprises a telephone.

10. The device of claim 1, wherein the processor automatically enables the sidetone further comprising:
determining volume of speech of the user as it would be observed by an unobstructed ear of the user; and
setting the sidetone in accordance with the determined volume of speech of the user.

11. A method, comprising:
receiving an electrical signal from a microphone of a device in response to sound;
analyzing the electrical signal to determine whether the sound received by the microphone comprises speech from a user;
upon determining the sound comprises speech from the user of the device, automatically enabling a sidetone, providing the sound to a first audio output transducer of the device; and
upon determining the sound is absent speech from the user, automatically attenuating the sidetone.

12. The method of claim 11, further comprising a binaural set of audio output transducers that comprise the first audio output transducer and a second audio output transducer.

13. The method of claim 11, wherein attenuating the sidetone comprises muting the sidetone.

14. The method of claim 11, wherein attenuating the sidetone comprises attenuating at least one sidetone frequency associated with signals from the microphone comprising at least one of environmental sound or sound other than speech from the user.

15. The method of claim 11, further comprising determining that speech received, via a network, from a far-end device is present and, in response, automatically attenuating the sidetone.

16. The method of claim 11, wherein the sound received by the microphone is provided, via a network, as electrical signals to a far-end device.

17. The method of claim 11, wherein the first audio output transducer generates sound in response to receiving electrical signals, via a network, from a far-end device.

18. The method of claim 11, further comprising:
determining volume of speech of the user as it would be observed by an unobstructed ear of the user; and
setting the sidetone in accordance with the determined volume of speech of the user.

19. A computer-readable medium coupled to a processor, the computer-readable medium comprising one or more computer readable instructions, the processor executing the one of more computer readable instructions to:
receive an electrical signal from a microphone of a device in response to sound;
analyze the electrical signal to determine whether the sound received by the microphone comprises speech from a user;
upon determining the sound comprises speech from the user of the device, automatically enabling a sidetone providing the sound to a first audio output transducer of the device; and
upon determining the sound is absent speech from the user, automatically attenuating the sidetone.

20. The computer-readable medium of claim 19, wherein automatically attenuating the sidetone comprises attenuating at least one sidetone frequency associated with signals from the microphone comprising at least one of environmental sound or sound other than speech from the user.
